(19) United States
(12) Patent Application Publication
(10) Pub. No.: US 2009/0000489 A1
(43) Pub. Date: Jan. 1, 2009

(54) COOKING APPARATUS

(76) Inventor: CHARLES Z. KRASZNAI, Bridgeport, CT (US)

Correspondence Address: Lawrence Cruz;Conair Corporation, One Cummings Point Road, STAMFORD, CT, 06902, US

(21) Appl. No.: 12/131,224

(22) Filed: Jun. 2, 2008

Related U.S. Application Data
(60) Provisional application No. 60/932,689, filed on Jun. 1, 2007.

(51) Int. Cl. A47J 37/06

(52) U.S. Cl. 99/376

(57) ABSTRACT

A cooking apparatus includes a lower housing and an upper housing with the lower housing and the upper housing adapted for relative movement between an open position and a closed position. Lower and upper food preparation plates are respectively mounted to the lower and upper housing. At least one of the lower and the upper food preparation plates is releasable from the respective lower and upper housing. The lower and upper food preparation plates have cooperating cooking surfaces adapted to cook a food product therebetween when the lower and upper housings are in the closed position. Lower and upper heaters are associated with the lower and upper food preparation plates for providing heat to the food product. The cooperating cooking surfaces of the lower and upper food preparation plates include complementary recesses for receiving the food product. The complementary recesses of the cooperating cooking surfaces may be dimensioned to accommodate a sandwich, an annular-shaped donut or a muffin. A release member may be in operative engagement with the one of the lower and upper food preparation plates. The release member is adapted for movement between a locked position securing the one of the lower and upper food preparation plates, and a release position releasing the one of the lower and upper food preparation plates to permit removal thereof.

### BACKGROUND

1. Technical Field

The present disclosure generally relates to be cooking appliances and, in particular, relates to a grilling apparatus having interchangeable plates for preparing a variety of food products including sandwiches, muffins, donuts, etc.

2. Discussion of Related Art

Grills, and in particular electric grills, are known. These devices are generally constructed with heating plates having a particular surface geometry for heating food placed thereon. The heating plates may be secured to a housing and heated by an electrical resistance heater. An example of a grill apparatus is disclosed in commonly assigned U.S. Pat. No. 7,109,442 to Steinberg, the entire contents of which are hereby incorporated by reference herein.

### SUMMARY

Accordingly, the present disclosure is directed to further improvements in cooking or grill apparatuses. In one embodiment of the present disclosure, a cooking apparatus includes a lower housing and an upper housing with the lower housing and the upper housing adapted for relative movement between an open position and a closed position. Lower and upper food preparation plates are respectively mounted to the lower and upper housing. At least one of the lower and the upper food preparation plates is releasable from the respective lower and upper housing. The lower and upper food preparation plates have cooperating cooking surfaces adapted to cook a food product therebetween when the lower and upper housings are in the closed position. Lower and upper heaters are associated with the lower and upper food preparation plates for providing heat to the food product. The cooperating cooking surfaces of the lower and upper food preparation plates may include complementary recesses for receiving the food product. The complementary recesses of the cooperating cooking surfaces may be dimensioned to accommodate a sandwich, an annular-shaped donut or a muffin. The upper and lower food preparation plates may include at least two pairs of complementary recesses.

A release member may be in operative engagement with the one of the lower and upper food preparation plates. The release member is adapted for movement between a locked position securing the one of the lower and upper food preparation plates, and a release position releasing the one of the lower and upper food preparation plates to permit removal thereof. Each of the at least one of the lower and the upper food preparation plates may be releasable from the respective lower and upper housing. In accordance with this feature, lower and upper release members are provided with each release member, and are adapted for movement between a locked position securing the respective food preparation plate to the respective housing and a release position releasing the one of the respective food preparation plate from the respective housing to permit removal therefrom.

### BRIEF DESCRIPTION OF THE DRAWINGS

The accompanying drawings, which are incorporated in and constitute a part of this specification, illustrate embodiments of the disclosure and, together with a general description of the disclosure given above, and the detailed description of the embodiment(s) given below, serve to explain the principles of the disclosure, wherein

FIG. 1 is a perspective view of a cooking apparatus in accordance with the principles of the present disclosure in a closed position;

FIG. 1A is a perspective view of the cooking apparatus in an open position;

FIG. 2 is a front plan view of the cooking apparatus;

FIGS. 3-4 are side plan views of the cooking apparatus;

FIGS. 5-6 is a top and bottom plan views respectively of the cooking apparatus;

FIG. 7 is a rear plan view of the cooking apparatus;

FIG. 8 is a perspective view with parts separated of the cooking apparatus;

FIG. 9 is a schematic circuit diagram;

FIGS. 10A-10E are views of the lower food preparation plates of the cooking apparatus;

FIGS. 11A-11E are views of the upper lower food preparation plates of the cooking apparatus;

FIG. 12 is a schematic view illustrating the release member for releasably securing the food preparation plates to their respective housings;

FIGS. 13A-13E are views of the lower food preparation plates of the cooking apparatus, and adapted for cooking a donut;

FIGS. 14A-14E are views of the upper lower food preparation plates of the embodiment of FIGS. 13A-13E;

FIGS. 15A-15E are views of an alternate embodiment of the lower food preparation plates of the cooking apparatus, and adapted for cooking a muffin; and

FIGS. 16A-16E are views of the upper food preparation plates of the embodiment of FIGS. 15A-15E.

### DETAILED DESCRIPTION

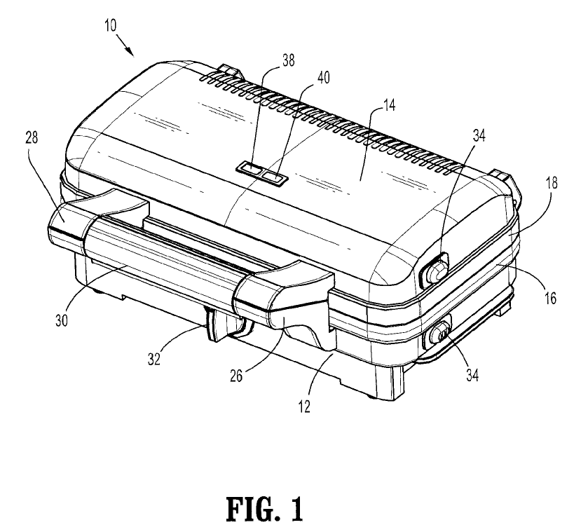

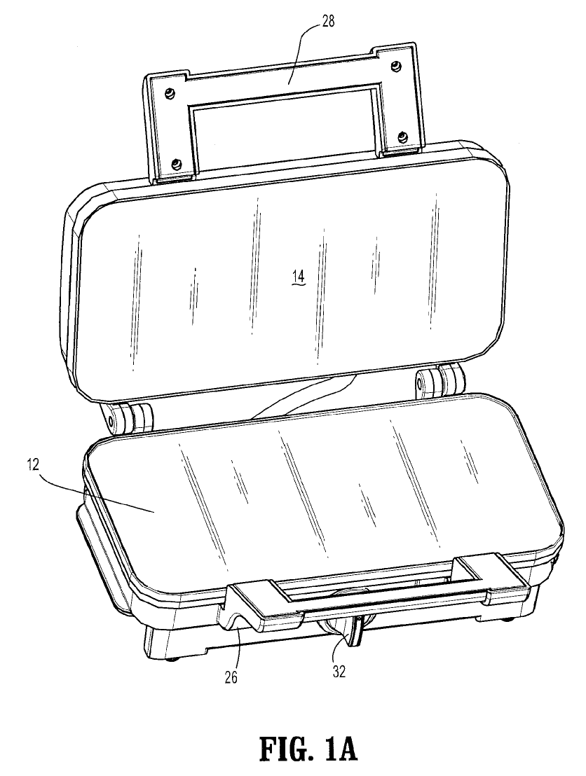

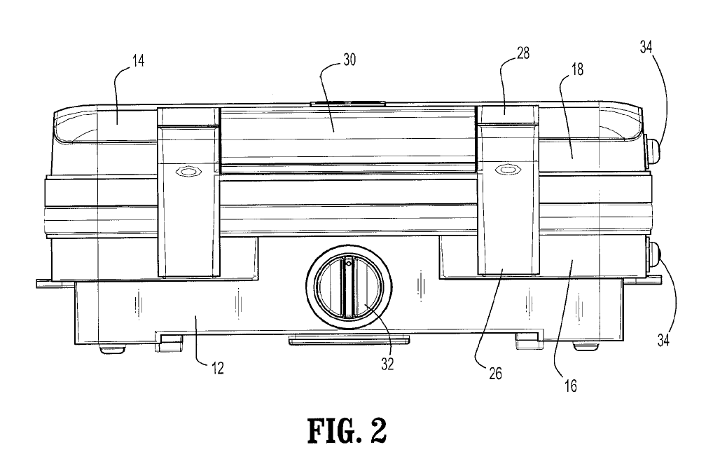

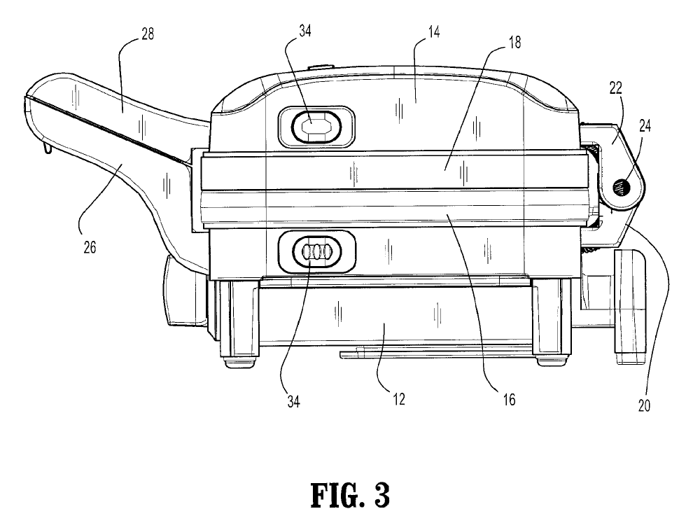

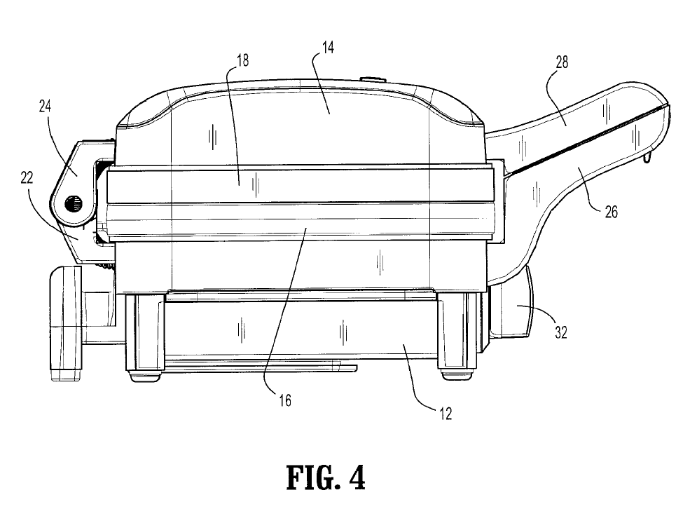

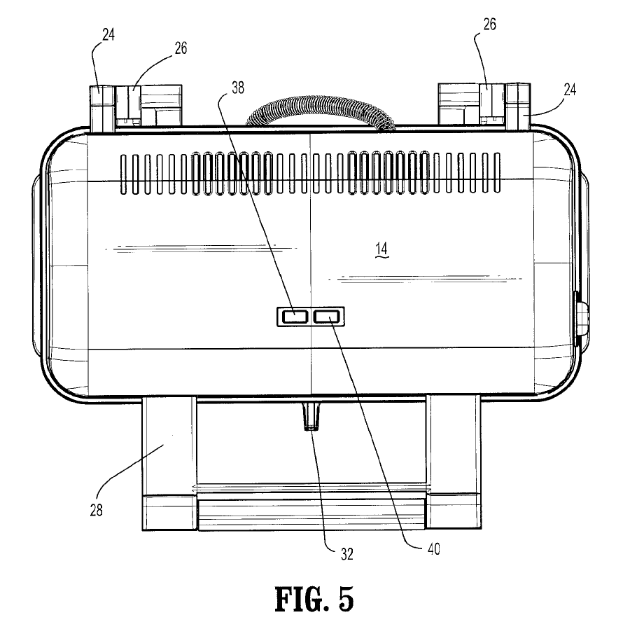

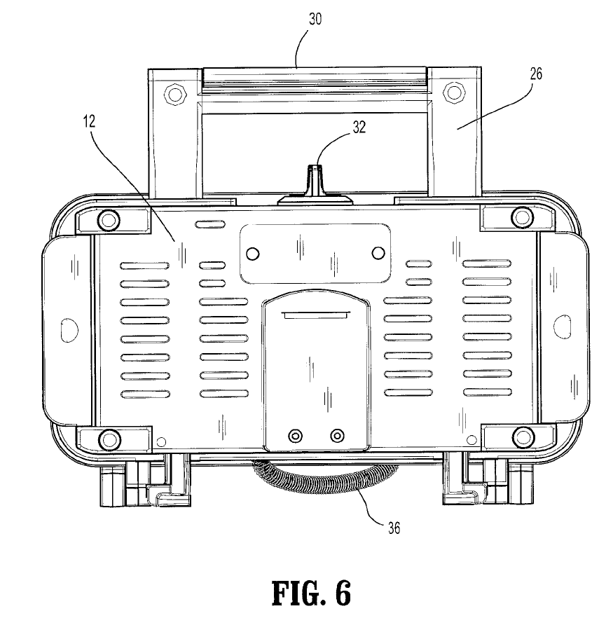

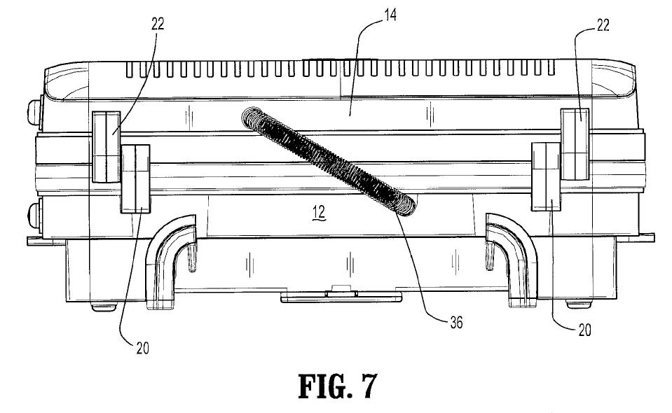

Referring now to the drawings wherein like references identical or similar elements throughout the several views, FIGS. 1-9 illustrate the cooking apparatus in accordance with the principles of the present disclosure. Cooking apparatus 10 is preferably a portable unit adapted for positioning on a table, countertop or the like. Cooking apparatus 10 includes lower housing 12, upper housing 14 and lower and upper food preparation plates 16, 18 respectively mounted to the lower and upper housings 12, 14. Food plates 16, 18 may be dimensioned for preparing food products including cooking, baking, or heating sandwiches, muffins, donuts etc. and will be discussed in greater detail herein below. Upper housing 14 is adapted to pivot relative to lower housing 12 between the closed position depicted in FIG. 1 and an open position depicted in FIG. 1A to receive the food substances and/or to the change the food plates 16, 18. In (FIG. 1A, food plates 16, 18 are removed). In one embodiment, lower and upper housing 12, 14 have respective pairs of lower and upper hinges 20, 22 depending from their rear surfaces. Lower and upper hinges 20, 22 are connected along pivot pin or member 24 to effect the pivotal connection between the two components.

As best depicted in FIG. 1, lower and upper housings 12, 14 further include respective lower and upper handles 26, 28 for engagement by the user. Handles 26, 28 may incorporate handle locker 30 which secures lower and upper handles 26, 28 in the approximated position for transport and/or storage. Locker 30 may be a resilient u-shaped element in cross-section which forms a snap fit about lower and upper handles to releasably secure to handles 26, 28 and lower and upper housings 12, 14 in the closed position. Temperature control knob 32 is centrally located on the front surface of lower housing 12 beneath lower and upper handles 26, 28. A pair or release buttons 34 are disposed adjacent the side surfaces of lower and upper housings 12, 14. Release buttons 34 are adapted to releasably secure food plates 16, 18 relative to lower and upper housings 12, 14. The rear surface of lower and upper housing 12, 14 may include a coil spring 36. Coil spring 36 may assist in opening lower and upper housing 12, 14 upon release or actuation of release buttons 34 and/or may limit the degree of pivotal movement of upper housing 14 relative to lower housing 12.

In addition, upper housing 14 may incorporate first and second lamps 36, 38. First lamp 36 may have a red cover plate to indicate to the user that the power is activated, i.e., in an activated mode. Second lamp 38 may have a green cover plate to indicate to the user that apparatus 10 is in a ready mode for cooking.

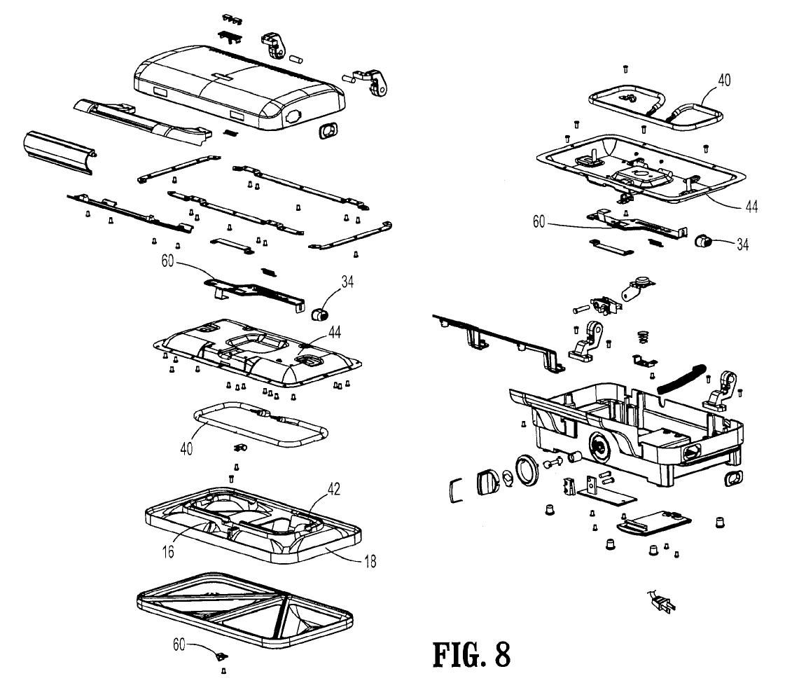

FIG. 8 is an exploded perspective view of cooking apparatus 10 illustrating the remaining components including the internal components. Lower and upper food plates 16, 18 each have heater 40 which is adapted for heating the respective food plates 16, 18 for preparation of the food item. Heaters 40 may reside within correspondingly dimensioned channels 42 within each of the back surface of lower and upper food plates 16, 18 and are electrically connected to the power cord through conventional means. Heaters 40 mounted adjacent lower and upper food plates 16, 18 may have reflectors 44 to enclose the heaters 40 to retain the heat within the plates 16, 18.

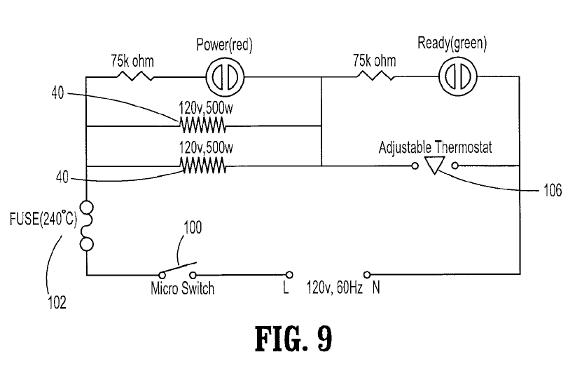

FIG. 9 is a circuit diagram of the electrical components of apparatus 10. The electrical components may include switch 100, fuse 102 heaters 40 and thermostat 106 associated with temperature control unit 32.

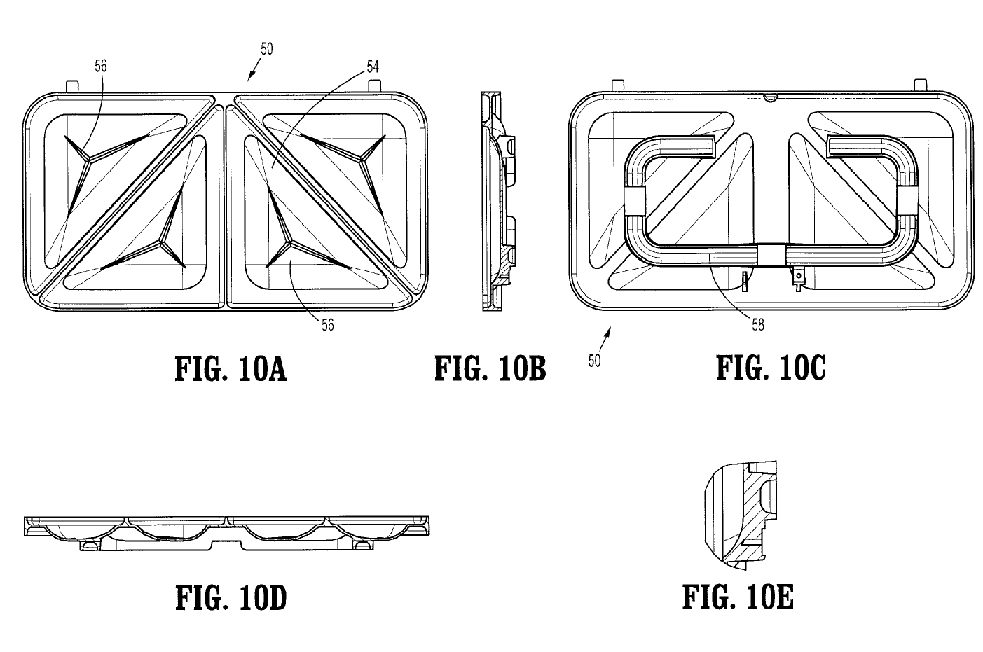

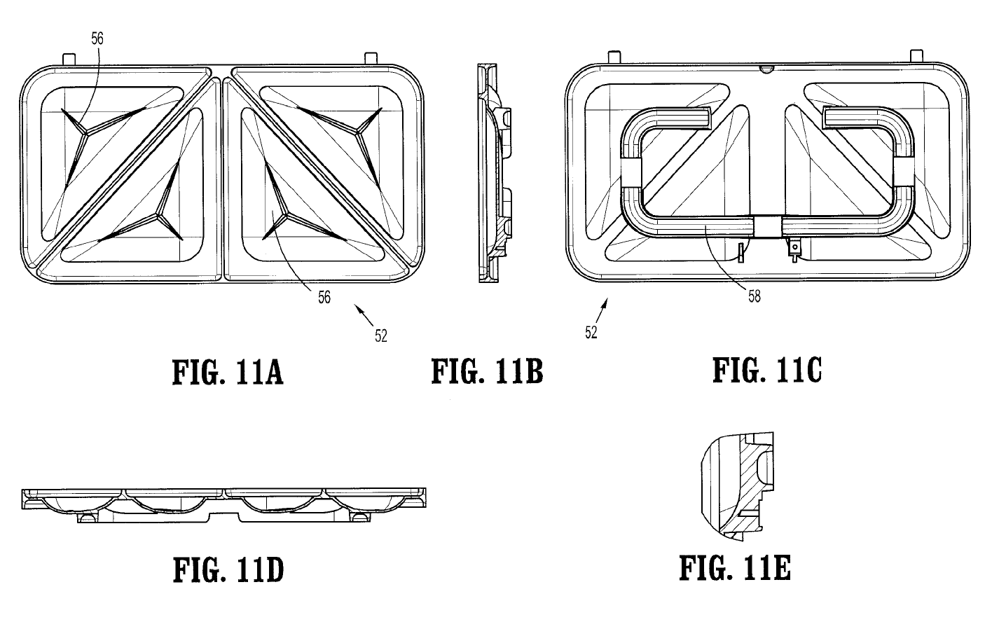

FIGS. 10A-10E and 11A-11E illustrate one set of food plates, in the form of lower and uppers sandwich plates 50, 52, which are adapted for incorporation into the cooking apparatus 10. Sandwich plates 50, 52 are adapted for heating and/or cooking a conventional sandwich. Preferably, the internal surfaces 54, i.e., the cooking surfaces which face each other and trap the sandwich therebetween, incorporate recesses 56 which generally correspond to a dimensioning of the sandwich. In one embodiment, recesses 56 define a generally triangular shape to accommodate a corresponding triangularly shaped sandwich half. Other shapes for the food receiving recesses 56 are also envisioned including, for example, square, rectangular, circular etc. Sandwich plates 50, 52 may incorporate corresponding pairs of food receiving recesses 56 to enable the user to prepare two sandwiches simultaneously within the cooking appliance 10.

The external or outer surfaces of sandwich plates 50, 52 incorporate channel 58 for accommodating the respective heaters 40 of the apparatus 10. Heaters 40 may or may not be components of sandwich plates 50, 52. For example, in one embodiment, heaters 50, 52 are permanently fixed to plates 50, 52. In the alternative, heaters 40 may be remove from channels 58 and incorporated into another set of plates, e.g., muffin plates.

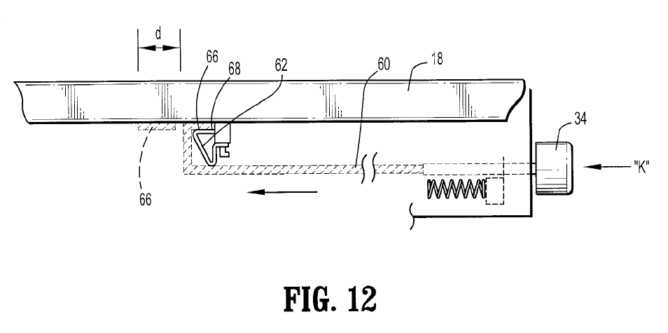

Sandwich plates 50, 52 may be releasably connected to lower and upper housings 12, 14. Any means for effecting the releasable connection are envisioned. In one embodiment best depicted in FIGS. 8 and 12 release buttons 34 are operatively connected to release plates 60 which engage corresponding structure on the sandwich plates 50, 52 or structure connected to or associated with the sandwich plates 50, 52 to release the sandwich plates 50, 52 upon depression of the release buttons 34. In one embodiment, release plates 60 engage plate lockers 62 affixed to the external surfaces of sandwich plates 50, 52. Release buttons 34 may be spring biased to an outward or locked position through conventional spring means 64. In the locked position of release button 34, ledge 66 of release plate 60 is received within locking recess 68 of plate locker 62. Locking recess 68 may be the gap defined between plate locker 62 and the lower surface of sandwich plate 50. In the release position, i.e., when release button 34 is depressed inwardly in the direction of arrow “k”, release plate 60 travels a predetermined distance “d” which displaces ledge 66 from locking recess 68 (shown in phantom in FIG. 12) thus releasing the ledge 66 and permitting removal of either sandwich plate 50, 52.

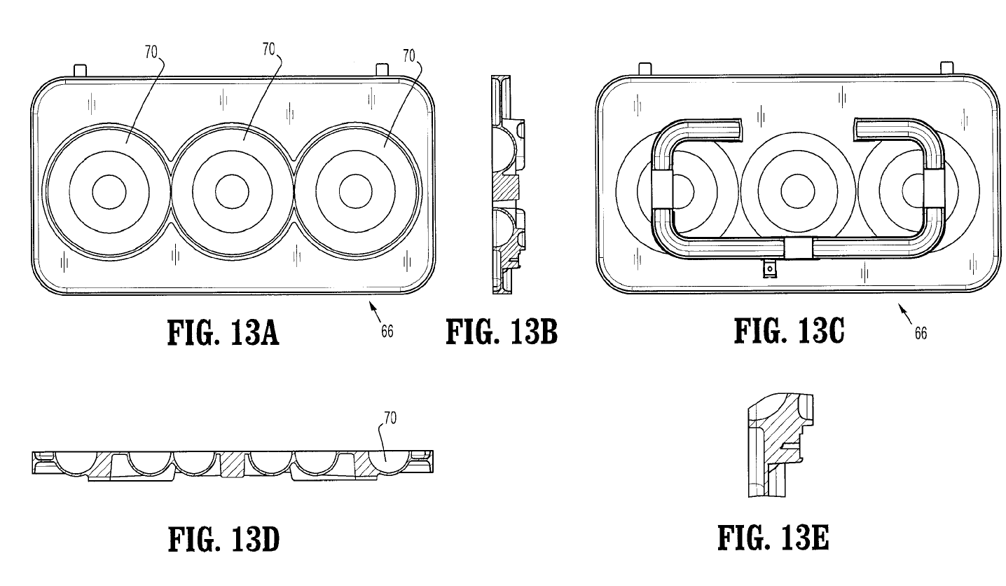

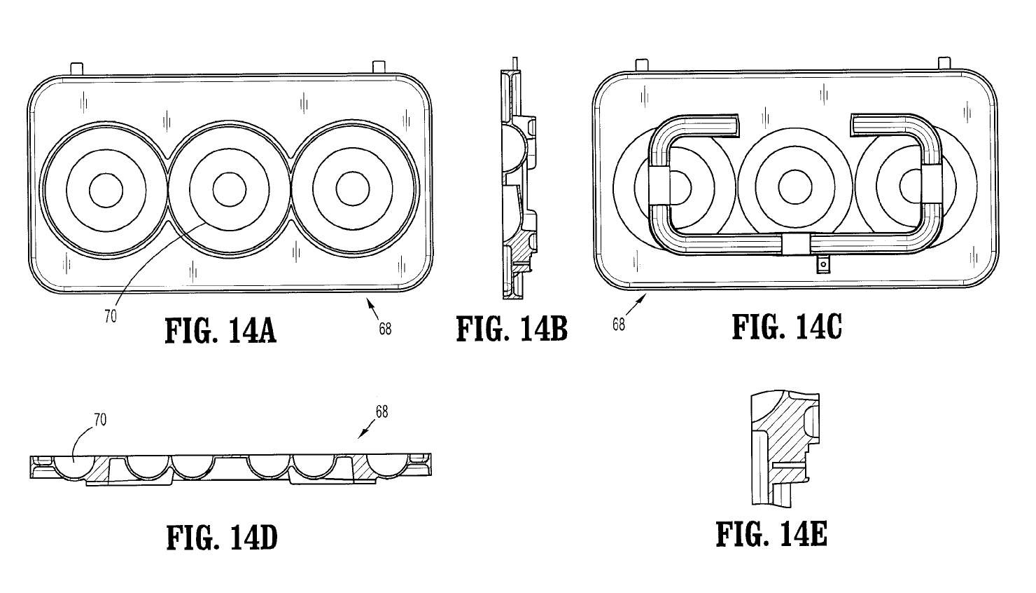

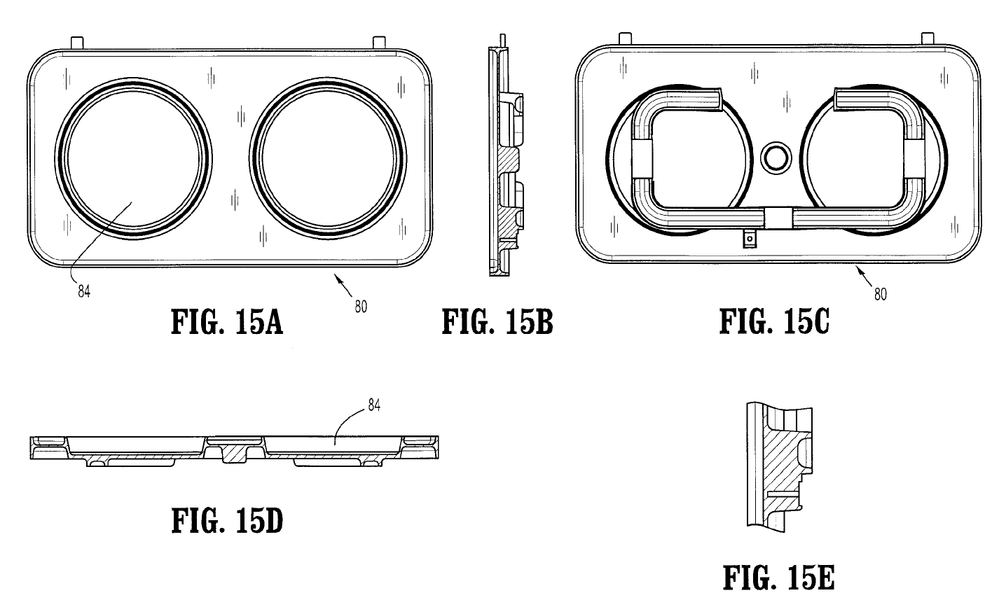

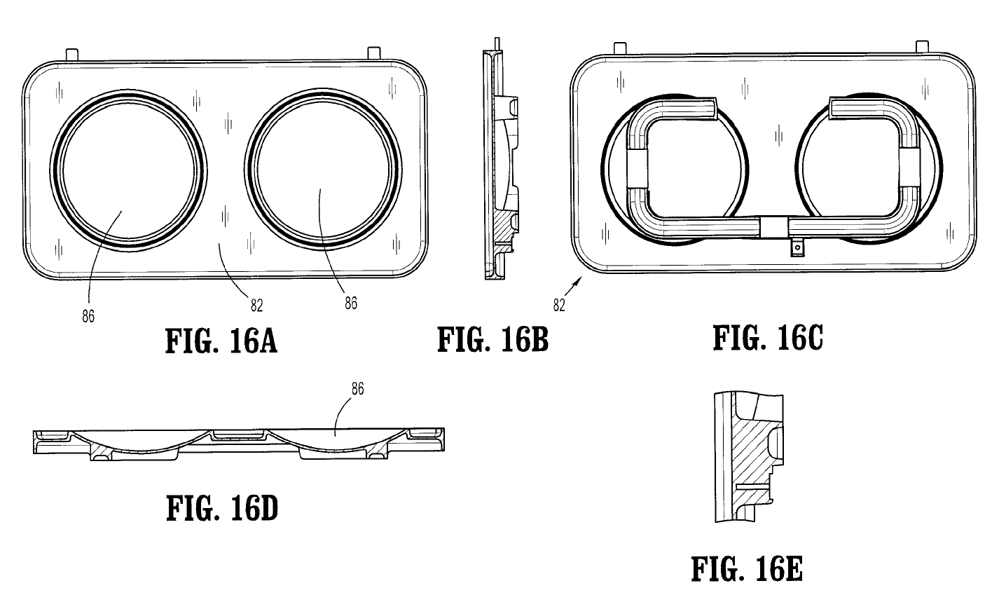

FIG. 13A-13E and 14A-14E illustrates an alternate embodiment of sandwich plates. In accordance with this embodiment, lower and upper plates 80, 82 include recess or molds 84 in the shape of a donut to bake, grill or heat a ring or annular shaped donut. Three donut molds 84 are shown although more or less than three molds 84 may be provided. FIGS. 15A-15E and 16A-16E illustrate another embodiment where lower and upper plates 86, 86 include respective molds or recesses 88, 90 in the shape of a muffin. Other molds, designs are also envisioned.

While the invention has been particularly shown, and described with reference to the preferred embodiments, it will be understood by those skilled in the art that various modifications and changes in form and detail may be made therein without departing from the scope and spirit of the invention. Accordingly, modifications such as those suggested above, but not limited thereto, are to be considered within the scope of the invention.

What is claimed is:

1. A cooking apparatus, which comprises:
a lower housing and an upper housing, the lower housing and the upper housing adapted for relative movement between an open position and a closed position;
lower and upper food preparation plates respectively mounted to the lower and upper housing, at least one of the lower and the upper food preparation plates being releasable from the respective lower and upper housing, the lower and upper food preparation plates having cooperating cooking surfaces adapted to cook a food product therebetween when the lower and upper housings are in the closed position; and
lower and upper heaters associated with the lower and upper food preparation plates for providing heat to the food product.

2. The cooking apparatus according to claim 1 wherein the cooperating cooking surfaces of the lower and upper food preparation plates include complementary recesses for receiving the food product.

3. The cooking apparatus according to claim 2 wherein the complementary recesses of the cooperating cooking surfaces are dimensioned to accommodate a sandwich.

4. The cooking recesses according to claim 3 wherein the recesses define a generally triangular profile.

5. The cooking apparatus according to claim 3 wherein the upper and lower food preparation plates include at least two pairs of complementary recesses

6. The cooking apparatus according to claim 2 wherein the complementary recesses of the cooperating cooking surfaces are dimensioned to accommodate one of a generally annular-shaped donut or a muffin.

7. The cooking apparatus according to claim 6 wherein the upper and lower food preparation plates include at least two pairs of complementary recesses to thereby accommodate at least two generally annular shaped donuts or at least two muffins.

8. The cooking apparatus according to claim 1 including a release member in operative engagement with the one of the lower and upper food preparation plates, the release member adapted for movement between a locked position securing the one of the lower and upper food preparation plates, and a release position releasing the one of the lower and upper food preparation plates to permit removal thereof.

9. The cooking apparatus according to claim 8 wherein each of the at least one of the lower and the upper food preparation plates is releasable from the respective lower and upper housing.

10. The cooking apparatus according to claim 9 including lower and upper release members, the lower and upper release members each adapted for movement between a locked position securing the respective food preparation plate to the respective housing and a release position releasing the one of the respective food preparation plate from the respective housing to permit removal therefrom.
